(19) United States
(12) Patent Application Publication
(10) Pub. No.: US 2006/0222125 A1
(43) Pub. Date: Oct. 5, 2006

(54) Systems and methods for maintaining synchronicity during signal transmission

(76) Inventors: John W. Edwards JR., Clinton, MA (US); Jeffrey Somers, Northboro, MA (US); Tim Wegner, Westborough, MA (US)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(21) Appl. No.: 11/095,173

(22) Filed: Mar. 31, 2005

(51) Int. Cl. H04L 7/00

(52) U.S. Cl. 375/354

(57) ABSTRACT

Systems and methods are disclosed for facilitating synchronous communications over an asynchronous communications link. Specifically, embodiments of the present invention provide systems and methods for transmitting high-speed signals while maintaining lock-step determinism using remote clock phase adjustments. Embodiments of the present invention also provide systems and methods for maintaining determinism through the use of synchronized time slice counters within the various components.

### FIELD OF THE INVENTION

The present invention relates generally to synchronous signal transmission between modules within a computer system, and more specifically, to systems and methods for maintaining synchronicity between multiple components within a fault-tolerant computer system.

### BACKGROUND OF THE INVENTION

As the speed and performance of digital computer systems increase, the demands on data interconnects that link the various components within these systems also increase. These interconnects, or communication links, connect computer systems, subsystems, chips or other components within a computer system, thereby enabling data exchange. Typically, this data is transferred as pulses of electrical energy through wires or other electrically conductive material. However, the data may also be conveyed wirelessly, via RF transmitters and receivers, as well as though pulses of coherent light, via through optical fibers.

Regardless of transmission medium, serial line protocols have increasingly been among the protocols of choice for communications links between internal system components. In theory, serial line protocols may be either synchronous or asynchronous. For synchronous communications, each connected component or device is typically connected to a common clock. The serial line also typically contains at least one wire or data path to transmit the common clock signal to interconnected components. In asynchronous (or non-synchronous) serial line communications, the serial line does not have a wire dedicated to clock signal transmission. Instead, if a clock signal is transmitted, it is sent using the data wires, either separately or embedded within a data signal. In many applications, asynchronous data is merely transmitted when possible, and is handled by any receiving component at the component's discretion.

In most typical computer applications, asynchronous serial links meet the needs of the hardware developers. These links transmit data quickly, efficiently, and inexpensively. As no-dedicated clock signal wire is necessary, the datapaths can be one wire smaller, the I/O interconnects can be one pin shorter, and the dependent microcircuitry can be simplified. Additionally, for most applications, asynchronous data arrival is good enough, and most users will neither notice nor object to slight delays in processing caused by the asynchronous transmission. Consequently, most off-the-shelf computer systems today make use of asynchronous serial lines for internal data transfers.

In fault-tolerant applications, however, individual components must often operate in synchronized, or lock-step, operation in order to maintain system-wide determinism.

### SUMMARY OF THE INVENTION

Thus, a need exists for improved methods and systems facilitating synchronous signal transfer among components over asynchronous serial lines. Further, a need exists to enable off-the-shelf computer systems with asynchronous internal serial lines to be used as fault-tolerant computer systems. Finally, within fault-tolerant computer systems, a need exists to enable deterministic computing among components, even as the signals are transmitted asynchronously between these components via high speed transmission channels.

In satisfaction of these needs, embodiments of the present invention provide systems and methods for transmitting high-speed signals while maintaining lock-step determinism using remote clock phase adjustments. Embodiments of the present invention also provide systems and methods for maintaining determinism through the use of synchronized time slice counters within the various components.

In accordance with one aspect of the invention, a synchronized communications system is provided. This system includes a transmitter, a receiver and an asynchronous communications link connecting the transmitter and the receiver. The transmitter includes an embedded clock and a round trip timer. Preferably, the transmitter and the round trip timer are configured to measure the round trip time required to send a signal to the receiver over the communications link and to receive an acknowledgement back. Thereafter, the round trip time is used to calculate a transmission delay. In addition, the transmitter is further configured to establish an appropriate offset for the embedded clock in order to counteract the effect of the transmission delay and to facilitate synchronous processing between the transmitter and the receiver. This synchronized communications system may be located within a fault tolerant computer system. In various embodiments, the embedded clock may produce a signal that is transmitted over the communications link and used by the receiver in order to synchronize the receiver's operations with those of the transmitter.

In accordance with another aspect of the invention, a method is provided for synchronizing a transmitter and a receiver through the use of a signal. Preferably, the transmitter includes a transmitter clock and an embedded clock and the receiver includes a receiver clock. Under this method, a signal is transmitted from the transmitter to the receiver, an acknowledgement is sent from the receiver to the transmitter, and the round trip transit time is calculated and recorded. Thereafter, an offset is added to the embedded clock, and the procedure is repeated until a stopping condition has been reached. Thereafter, a preferred offset is selected and the embedded clock is adjusted accordingly. In various embodiments, an embedded clock signal generated by the embedded clock may be sent across the communications link from the transmitter to the receiver, which may in turn use the embedded clock signal to synchronize its operations with those of the transmitter.

In accordance with a third aspect of the invention, a synchronized communications system is provided, which system includes a transmitter, a receiver and an asynchronous communications link. The transmitter includes a transmitter clock and a first time slice counter. The receiver includes a receiver clock, a buffer and a second time slice counter, wherein each time slice counter is configured to periodically and synchronously produce a signal representing a time slice. The asynchronous communications link connects the transmitter and the receiver. In this system, the transmitter is configured such that it transmits data packets across the communications link only during a time slice. Preferably, the buffer is configured to receive and store each packet sent across the communications link, and the buffered packets are processed by the receiver upon the next time slice.

In accordance with a final aspect of the invention, a method for transmitting a signal from a transmitter to a receiver over an asynchronous communications link is provided. Preferably, the transmitter includes a transmitter clock and the receiver includes a receiver clock, with each clock having its own period. Preferably, the link variance across the communications link is calculated. Thereafter, a time slice which is greater than the link variance and is also the least common denominator between the transmitter clock period and the receiver clock period is calculated. Finally, the signal is transmitted from the transmitter to the receiver across the communications link during the time slice. In various embodiments, a buffer is configured to receive and store each packet sent across the communications link until the packets are declared valid and the next time slice has occurred.

### BRIEF DESCRIPTION OF THE DRAWINGS

These and other aspects of this invention will be readily apparent from the detailed description below and the appended drawings, which are meant to illustrate and not to limit the invention, and in which:

FIG. 1 is a block diagram depicting an overall system for sending a signal from a transmitter to a receiver, in accordance with various embodiments of the claimed invention.

FIG. 2 is a block diagram depicting a synchronized communications system for sending a phase adjusted signal from a transmitter to a receiver over a communications link.

FIG. 3 is a flowchart illustrating a method for synchronizing a transmitter and receiver through the use of a phase adjusted signal.

FIG. 4 is a block diagram depicting a synchronized communications system for sending signals from a transmitter to a receiver during specified time slices.

The claimed invention will be more completely understood through the following detailed description, which should be read in conjunction with the attached drawings. In this description, like numbers refer to similar elements within various embodiments of the present invention.

### DETAILED DESCRIPTION OF THE PREFERRED EMBODIMENTS

The claimed invention provides methods and systems for providing deterministic operation of computer components connected via an asynchronous communications link.

As discussed previously, most presently available computer systems rely upon high speed busses to transmit data among components within the computer system. These components may include low bandwidth items (e.g. mice, keyboards and joysticks) or high bandwidth components (e.g. processors, memory subsystems, graphics cards). Regardless of component type, the devices on either end of a communications link may be characterized as transmitters and receivers, where the transmitter is sending data to the receiver across a communications link.

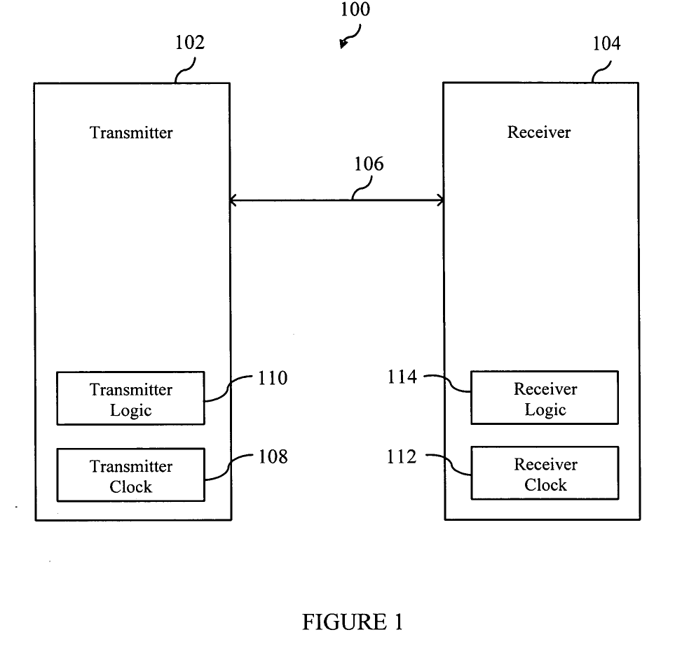

FIG. 1 is a block diagram depicting an overall system 100 for sending a signal from a transmitter 102 to a receiver 104, in accordance with various embodiments of the claimed invention. The transmitter 102 preferably comprises transmitter logic 110 which operates and processes instructions at a frequency set by a transmitter clock 108. Similarly, the receiver 104 preferably comprises receiver logic 114 which operates and processes instructions at a frequency set by the receiver clock 112. As illustrated, the transmitter 102 and the receiver 104 are connected via a communications link 106.

In many modern computer systems 100, the communications link 106 comprises a high speed serial bus linking the transmitter 102 and the receiver 104. Set protocols and standards govern the manufacture and use of the link 106, so that various devices can communicate via the same link 106. One such protocol is the PCI-SIG's standard Peripheral Component Interconnect Express, or PCI-Express, protocol.

PCI-Express is a two-way, serial connection that carries data in packets along two pairs of point-to-point data lanes. Estimated bit rates for PCI-Express reach 2.5 Gigabits per second per lane direction, which is fast enough to provide an I/O architecture suitable for high speed data interconnects such as USB 2.0, InfiniBand and Gigabit Ethernet.

Typically, the PCI-Express serial connection, or bus, is clocked independently from the devices it connects. This facilitates isochronous and asynchronous communications. Isochronous communications are necessary for processes where data must be delivered within certain time constraints. For example, multimedia streams typically require an isochronous transport mechanism to ensure that data is delivered as fast as it is displayed and to ensure that the audio is synchronized with the video. Asynchronous communications refer to processes in which data streams can be broken by random intervals, where packets may arrive at their destinations at any point in time. Both asynchronous and isochronous communications may be contrasted with synchronous processes, in which data streams can only be delivered only at specific intervals or according to a common clock signal.

Because PCI-Express is readily available and because most processes need only asynchronous or isochronous communications among components, the majority of computer systems produced today include internal busses which operate according to PCI-Express, or similar standards.

Conversely, fault tolerant computers typically require that their various components operate deterministically. This means that the output for each component must be able to be predicted with absolute certainty. As a component's output is necessarily a function of its input, asynchronous communications alone are insufficient for deterministic computing applications. Accordingly, existing deterministic computing systems have typically relied upon synchronous communications links between internal components in order to facilitate data transfer.

The claimed invention makes use of asynchronous and isochronous communications lines, such as PCI-Express busses, in order to facilitate deterministic processing. Accordingly, disclosed herein are at least two primary techniques which accomplish that goal. These techniques include Remote Clock Phase Determinism and Time Slice Determinism, which are discussed below.

Remote Clock Phase Determinism

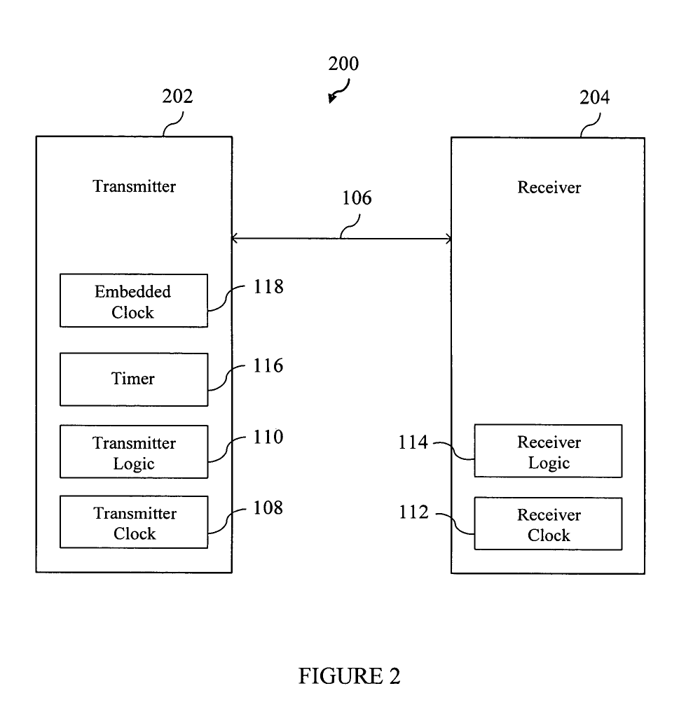

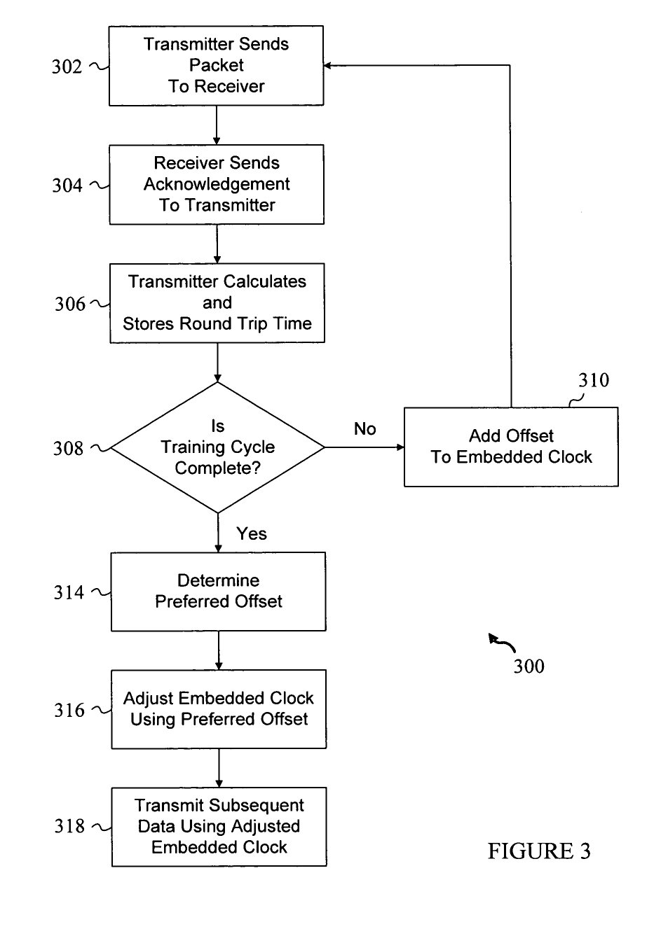

Remote Clock Phase Determinism is a system and method by which a transmitter and receiver may operate deterministically, even when connected by an asynchronous bus. Embodiments of this technique are discussed below in reference to FIGS. 2 and 3.

FIG. 2 is a block diagram depicting a synchronized communications system 200 for sending a phase adjusted signal from a transmitter 202 to a receiver 204 over a communications link 106. Preferably, the transmitter 202 comprises transmitter logic 110 and a transmitter clock 108, as discussed previously. Similarly, the receiver 204 preferably comprises receiver logic 114 and a receiver clock 112.

In this embodiment, the transmitter 202 also comprises an embedded clock 118 and a timer 116. The timer 116 is used to calculate the round trip time necessary for the transmitter 202 to send a signal or packet across the communications link 106 to the receiver 204, and for the receiver 204 to reply with an acknowledgement. The timer 116 may calculate the round trip time in clock cycles, in real time, or via it's own incremental counter. The embedded clock 118 is a second clock preferably located within the transmitter 202. Preferably, the embedded clock 118 is adjustable based upon instructions received from the transmitter logic 110 or other elements within the transmitter 202. In addition, the embedded clock 118 preferably generates an embedded clock signal, which may be transmitted across the communications link 106 either alone, or together with other data or instructions. The embedded clock signal may also be juxtaposed or embedded within the data and instructions transmitted across the communications link 106.

The operation of the communication system 200 depicted in FIG. 2 will now be discussed with reference to FIGS. 2 and 3.

FIG. 3 is a flowchart illustrating a method for synchronizing a transmitter 202 and receiver 204 through the use of a phase adjusted signal. This method preferably comprises two stages: training and normal operation.

The training cycle begins at startup, or upon the occurrence of external events or signals which trigger initiation of the training cycle. Initially, the transmitter 202 sends a signal to the receiver 204 via the communications link 106 (Step 302). This signal may contain data packets, instructions, the embedded clock signal, or any other information which may be interpreted by the receiver 204 and which will cause the receiver 204 to send an acknowledgement to the transmitter 202.

Upon receipt of the signal, the receiver 204 replies to the transmitter 202 by sending an acknowledgement over the communications link 106 (Step 304). This acknowledgement may be a copy of the originally transmitted signal, a modified copy of the original signal, a simple “acknowledged” packet, or any other data stream known by those skilled in the art to indicate safe receipt of the originally transmitted signal.

The timer, running simultaneously with the send-receive-acknowledge process described above then calculates and stores a round trip time (Step 306). If present, any offset currently applied to the embedded clock 118 is also stored and correlated with that particular round trip time.

At this point, the transmitter 202 determines whether or not the training cycle is complete (Step 308). Preferably, the training stage would be deemed complete upon the occurrence of one or more stopping conditions. These stopping conditions may include, without limitation:
Repetition of the training cycle a predetermined number of iterations;
Repetition of the training cycle for a predetermined period of time; or
Sweeping through the period of the embedded clock 118 through successive training cycle iterations coupled with incrementally increasing offsets applied to the embedded clock.

Assuming a stopping condition was not met, an offset is preferably added to the embedded clock (Step 310). This offset preferably comprises an incremental adjustment forward or backward. In various embodiments, the offset may shift the phase of the embedded clock 118 with reference to the transmitter clock 108, the receiver clock 112 or other system-wide clocks (not illustrated). This offset may then be used to shift the time which the next signal is transmitted by the transmitter 202. Alternately, the embedded clock's signal may be included with the next signal transmitted to the receiver 204. The receiver 204, in turn, may receive the embedded clock signal, and may appropriately adjust the timing of its operations, and specifically, the processing of any data received over the communications link 106 and processed by the receiver logic 114. Thus, the receiver may use the embedded clock, with any present offset, to clock in and process data. The training cycle repeats, starting again with Step 302, until a stopping condition is met.

Once a stopping condition is met, the training cycle is deemed complete (Step 308) and normal operation begins. At this point, the transmitter 202 determines a preferred offset to apply to the embedded clock 118 (Step 314). In order to determine a preferred offset, the transmitter 202 examines all round trip times to assess which round trip time appeared most frequently during the training cycle. For this value, the corresponding minimum and maximum offsets are collated, and the average offset is deemed the preferred offset. This will be explained in more detail in connection with Table 1, below.

After a preferred offset has been established (Step 314) the embedded clock is adjusted using this preferred offset (step 316). Thereafter, the signal generated by the adjusted, embedded clock is transmitted, together with all subsequent data packets, from the transmitter 202 to the receiver 204 via the communications link 106. As before, the receiver 204 preferably uses the adjusted embedded clock signal in order to clock in data from the communications link 106. The adjusted embedded clock signal is then used for subsequent processing by the receiver 204 and the receiver logic 114. Thus, the receiver logic 114 will process instructions synchronously with the transmitter logic 110 because the adjusted embedded signal will compensate for any delay inherent in the communications link 106. With the ability to process data synchronously, the transmitter 202 and the receiver 204 will be able to proceed deterministically, and will thus enable fault-tolerant processing within the context of a standard, off-the-shelf computer system.

In order to facilitate this synchronous processing, it is important that the preferred offset be chosen properly. As described previously, Table 1 illustrates an exemplary calculation of a preferred offset in accordance with this embodiment of the invention.

TABLE 1
Exemplary Calculation of a Preferred Offset.

| Time Adjustment (ns) | Round Trip Counter Value |
|---|---|
| 0 | 7 |
| 1 | 7 |
| 2 | 8 |
| 3 | 8 |
| 4 | 8 |
| 5 | 8 |
| 6 | 8 |
| 7 | 8 |
| 8 | 9 |
| 9 | 9 |

In the exemplary embodiment illustrated by Table 1, assume that the transmitter clock 108 operates at 100 MHz and an offset of one nanosecond is applied to the embedded clock 118 through each iteration of the training cycle. With each iteration, the transmitter 202 calculates and stores the round trip time for each transmit-receive-acknowledge cycle, along with the offset applied (Step 306). In this example, the Timer 116 increments an internal counter measuring this round trip time. Table 1 illustrates the values obtained for ten iterations of the training cycle. Thus, for the first iteration, no offset is applied to the embedded clock 118, and the round trip counter value is seven. For the second iteration, a one nanosecond delay is applied to the embedded clock 118, and the round trip counter value is also seven. The process continues until at the tenth iteration, a nine nanosecond delay is applied to the embedded clock, and the round trip counter value is nine.

As is evident from the table, the counter values which appeared most frequently throughout the ten iterations were counter values of eight. Thus, the transmitter 202, looks up the minimum and maximum delay values for a counter value of eight, which are 2 ns and 8 ns, accordingly. The preferred offset for this example is the average offset, or:

Preferred Offset=(Min+Max)/2

Preferred Offset=(2 ns+7 ns)/2

Preferred Offset=4.5 ns.

Thus, the embedded clock 118 would be adjusted by the preferred offset of 4.5 ns, and normal operation would continue accordingly. Thereafter, all subsequent transmissions would include the embedded clock signal as adjusted by 4.5 ns.

In alternate embodiments, the time adjustment applied may be rounded to the nearest whole number, or five nanoseconds. Furthermore, in alternate embodiments, the preferred offset need not be the average offset, and may comprise the median offset, or an offset reasonably close to the average or median offset. Although other offsets may be used, they would be less desirable, as the likelihood of sending data across a clock boundary increases as the offsets push the embedded clock towards the edge values of the round trip counter, and by doing so, moves closer to a non-determinism point.

Another example is illustrated by Table 2 below:

TABLE 2
Exemplary Calculation of another Preferred Offset.

| Time Adjustment (ns) | Round Trip Counter Value |
|---|---|
| 0 (10) | 8 |
| 1 (11) | 8 |
| 2 (12) | 8 |
| 3 (13) | 8 |
| 4 | 9 |
| 5 | 9 |
| 6 | 7 |
| 7 | 7 |
| 8 | 8 |
| 9 | 8 |

In the exemplary embodiment illustrated by Table 2, assume again that the transmitter clock 108 operates at 100 MHz and an offset of one nanosecond is applied to the embedded clock 118 through each iteration of the training cycle. With each iteration, the transmitter 202 again calculates and stores the round trip time for each transmit-receive-acknowledge cycle, along with the offset applied (Step 306). In this example, however Table 2 illustrates ten different values obtained for ten iterations of the training cycle. Thus, for the first iteration, no offset is applied to the embedded clock 118, and the round trip counter value is eight. For the second iteration, a one nanosecond delay is applied to the embedded clock 118, and the round trip counter value is also eight. The process continues until at the tenth iteration, a nine nanosecond delay is applied to the embedded clock, and the round trip counter value is eight. Under this scenario, the training cycle has presumably crossed a period boundary.

A period boundary exists when the training cycle crosses a period edge of the transmitter clock 108. If a period boundary is crossed during the training cycle, the round trip values measured are preferably shifted such that the embedded clock 118 can be adjusted relative to the transmitter clock 108. This situation is illustrated above in Table 2.

As is evident from Table 2, the counter values which appeared most frequently throughout the ten iterations were again counter values of eight. However, if a 4.5 ns offset were applied to the embedded clock 118, the round trip counter value would register nine, not eight. Thus, it is readily apparent that a period boundary was crossed during the training cycle. In this case, improper entries in the table must be shifted by one clock period, or 10 ns, in order to compensate. Thus, the nine nanosecond delay would remain the same, along with its round trip counter value of eight. The delays for other entries corresponding in a round trip counter value of eight would be shifted accordingly. Thus, 0 ns would become 10 ns, Ins would become 11 ns, and so on, as indicated in parenthesis in Table 2.

Thereafter, the transmitter 202, again looks up the minimum and maximum delay values for a counter value of eight, which are 8 ns and 13 ns, accordingly. The preferred offset for this example is the average offset, or:

Preferred Offset=(Min+Max)/2

Preferred Offset=(8 ns+13 ns)/2

Preferred Offset=10.5 ns

Preferred Offset=0.5 ns (subtracting 10 ns for one clock period)

With the preferred offsets so calculated, the transmitter 202 and receiver 204 would again be able to proceed deterministically, and will thus enable fault-tolerant processing within the context of a standard, off-the-shelf computer system.

One skilled in the art will recognize the many advantages inherent in this system. Specifically, embodiments of the claimed invention allow for deterministic processing by both a transmitter and a receiver, without any modifications to a receiver or the receiver's logic, and over an asynchronous communications line. Furthermore, this system allows off-the-shelf computer systems to serve as fault-tolerant computer systems, as they may now be operated deterministically.

With Remote Clock Phase Determinism thus described, we will now turn to the second technique for facilitating deterministic processing, namely Time Slice Determinism.

Time Slice Determinism

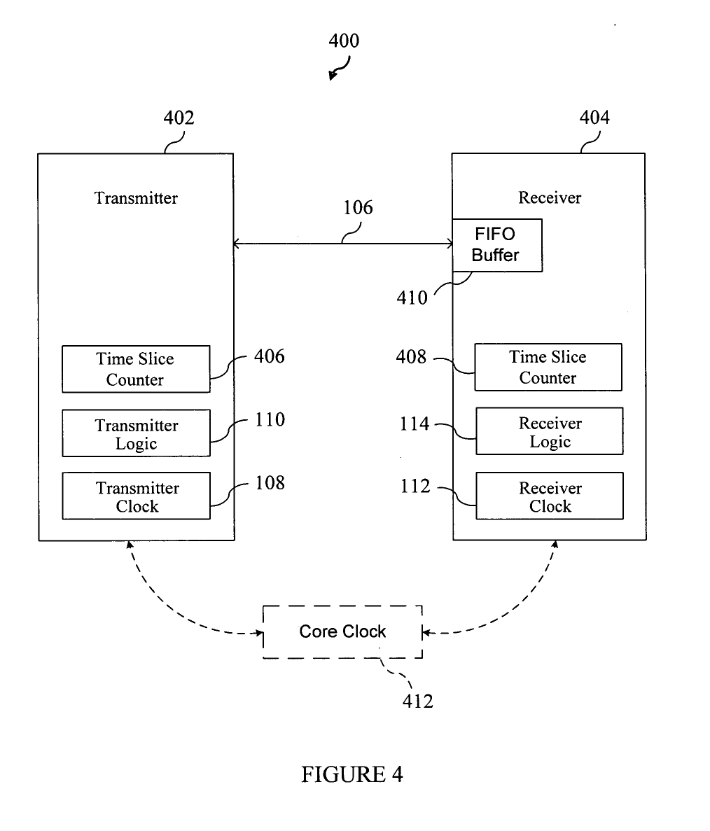

Time Slice Determinism is a related system and method by which a transmitter and receiver may operate deterministically, even when connected by an asynchronous bus. Embodiments of this system are built around knowing the total variance across a communications link a priori. By restricting the times that a transmitter and receiver process packets, one can create a deterministic transfer regardless of transmission medium. This may be done through the use of a time slice, or window of time, during which packets may be sent, received and processed. Each time slice is preferably the same length, and is preferably measured in real time. In alternate embodiments, however, time slices may be represented by a fixed number of clock cycles from a core clock or other clock, so long as the time slices at each component have the same period. Embodiments incorporating Time Slice Determinism are discussed below in reference to FIG. 4.

FIG. 4 is a block diagram depicting a synchronized communications system 400 for sending signals from a transmitter 402 to a receiver 404 during specified time slices.

As illustrated, the transmitter 402 and the receiver 404 are connected via a communications link 106. As before, the transmitter 402 preferably comprises transmitter logic 110 which operates and processes instructions at a frequency set by a transmitter clock 108. Similarly, the receiver 404 preferably comprises receiver logic 114 which operates and processes instructions at a frequency set by the receiver clock 112. The receiver also comprises a FIFO buffer 410, which serves to store signals received via the communications link 106 until such time as they can be processed.

In this embodiment, the transmitter 402 and receiver 404 each also comprise respective time slice counters 406, 408. The time slice counters 406, 408 operate synchronously, and measure slices of time in order to synchronize processing between the transmitter 402 and the receiver 404. The time slice counters 406, 408 are preferably initialized simultaneously via an optional shared reset signal (not illustrated) or common core clock 412. The time slice counters 406, 408 then increment their time slice periods as would any other clock, and facilitating synchronous transfer between the transmitter 402 and receiver 404.

Preferably, the time slice may be defined a priori and may be hardwired or pre-programmed into the time slice counters 406, 408. Optionally, the time slice counters 406, 408 may be re-programmed at a later time, and re-initialized simultaneously, so as to use the newly defined time slice.

The size of a time slice is first determined by establishing the maximum and minimum delays that a signal may encounter as it travels from the transmitter 402 to the receiver 404 across the communications link. The difference between the maximum and minimum delays is the link variance. Link variance can be determined by the designer a priori, or established later, through experimentation, according to techniques generally known by those skilled in the art. Preferably, link variance should account for asynchronous clock domain crossings, transmission variance and clock recovery affects. Preferably, the link variance should be calculated in real time, rather than clock cycles, due to the potential differences in clock frequencies encountered across the link. The time slice period must be greater than the link variance.

In addition to being greater than the link variance, the time slice period must be an integer number of clock cycles of the transmitter clock 108 and the receiver clock 112. Preferably, the time slice period is defined as the lowest common denominator among these two clocks' periods. Notably, the clock frequency for the communications link 106 may be disregarded when establishing the time slice period. In sum, the time slice should be defined as the lowest common denominator of the periods of the transmitter clock 108 and receiver clock 112 which is still greater than the total link variance.

In operation, the transmitter 402 will only allow packets to be sent on time slice boundaries. Preferably, the packets will travel across the communications link 106 and will be stored by the receiver 404 in the FIFO buffer 410 until they are ready to be processed. In the receiver 404, the time slice counter 408 may be offset slightly to account for any fixed delay present in the communications link 106. Such an offset will guarantee that the earliest a packet can be received will be early in the time slice, and consequently that packets transmitted during a particular time slice will be received during the same time slice, as the designated time slice is greater than the fixed delay.

As is typical with asynchronous communications links, packets sent from the transmitter 402 to the receiver 404 will preferably include a packet start bit or sequence. To avoid confusion with other bits, the start bit is preferably twice the size of any other bit in the transmission. The end of a packet is also preferably followed by a stop bit, which tells the receiver 404 that the packet has come to an end, that it should begin looking for the next start bit, and that any bits it receives before getting the next start bit should be ignored. To ensure data integrity, a parity bit is often added between the last bit of data and the stop bit. The parity bit makes sure that the data received is composed of the same number of bits in the same order in which they were sent.

When a start bit or sequence is received, the total length of the packet is preferably sampled. Based upon the length of the packet, the receiver logic 114 will preferably calculate the number of time slices which will be required to receive the entire data stream. The receiver will then wait that number of slices and then declare the packet valid upon the next time slice. Finally, the packet will be released by the FIFO buffer 410, and the receiver will process it accordingly.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A synchronized communications system comprising:
a transmitter comprising an embedded clock;
a receiver; and
an asynchronous communications link connecting the transmitter and the receiver;
wherein the transmitter is configured to establish an appropriate offset for the embedded clock in order to counteract the effect of a transmission delay between the transmitter and the receiver.

2. The system of claim 1, further comprising a round trip timer configured to measure the round trip time required to send a signal to the receiver over the communications link and to receive an acknowledgement back, the round trip time used to calculate the transmission delay.

3. The system of claim 1, wherein the transmitter and receiver are located within a fault tolerant computer system.

4. The system of claim 2, wherein the transmitter further comprises a transmitter clock.

5. The system of claim 4, wherein the round trip timer measures the round trip time relative to the transmitter clock.

6. The system of claim 5, wherein the signal comprises an embedded clock component and a data component, the embedded clock component based upon the embedded clock.

7. The system of claim 6, wherein the receiver is configured to use the embedded clock component to process the data component.

8. The system of claim 7, wherein after the offset has been established, the embedded clock is adjusted such that all future signals communicated between the transmitter and the receiver use the adjusted embedded clock.

9. A method for synchronizing a transmitter and a receiver, the transmitter having a transmitter clock and an embedded clock, the method comprising:
adding an offset to the embedded clock such that the transmitter and receiver operate in synchrony.

10. The method of claim 9, further comprising the step of calculating a transmission delay between the transmitter and receiver, such that the offset added to the embedded clock compensates for the transmission delay.

11. The method of claim 10, further comprising the step of transmitting a signal from the transmitter to the receiver containing an embedded clock signal, such that the receiver operates in lockstep with the transmitter through the use of the embedded clock signal.

12. The method of claim 11, wherein the transmitter and receiver are located within a fault-tolerant system.

13. A method for synchronizing a transmitter and a receiver through the use of a signal, the transmitter having a transmitter clock and an embedded clock, the receiver having a receiver clock, the method comprising:
(a) transmitting the signal from the transmitter to the receiver;
(b) transmitting an acknowledgement from the receiver to the transmitter;
(c) calculating and recording a round trip transit time defining the period between when the signal was sent by the transmitter and the acknowledgement was received by the transmitter;
(d) adding an offset to the embedded clock;
(e) repeating steps (a) through (d) until a stopping condition has been reached; and
(f) thereafter, selecting a preferred offset and adjusting the embedded clock accordingly.

14. The method of claim 13, wherein the signal comprises an embedded clock component and a data component, the embedded clock component based upon the embedded clock.

15. The method of claim 14, further comprising:
(g) after the embedded clock has been adjusted, transmitting all subsequent data components with adjusted embedded clock components based upon the adjusted embedded clock.

16. The method of claim 15, further comprising:
(h) using the adjusted embedded clock in the receiver to process the data component.

17. The method of claim 13, wherein the preferred offset is based upon the median round trip transit time.

18. The method of claim 13, wherein the preferred offset is based upon the average round trip transit time.

19. The method of claim 13, wherein the stopping condition comprises repeating steps (a) through (d) a predetermined number of times.

20. The method of claim 13, wherein the stopping condition comprises repeating steps (a) through (d) until the embedded clock has been measured for each possible phase of the transmit clock.

21. The method of claim 13, wherein, the step of adjusting the transmitter clock further comprises adjusting the phase of the embedded clock forward or backward with respect to the transmitter clock.

22. A synchronized communications system comprising:
a transmitter comprising a transmitter clock and a first time slice counter;
a receiver comprising a receiver clock, a buffer and a second time slice counter, each of the first and second time slice counters configured to periodically and synchronously produce a signal representing a time slice; and
an asynchronous communications link connecting the transmitter and the receiver;
wherein, the transmitter is configured such that it transmits data packets across the communications link only during a time slice.

23. The system of claim 22, wherein the buffer is configured to receive and store each packet sent across the communications link.

24. The system of claim 23, wherein the receiver is configured to obtain from the buffer and process each packet received only after the packet is declared valid.

25. The system of claim 24, wherein each packet is declared valid after the receiver waits a calculated number of time slices after the packet is first received such that the entire packet is received before it is processed.

26. The system of claim 22, wherein the transmitter and receiver are located within a fault tolerant computer system.

27. The system of claim 22, wherein the buffer comprises a FIFO buffer.

28. A method for transmitting a signal from a transmitter to a receiver over an asynchronous communications link, the transmitter having a transmitter clock and the receiver having a receiver clock, the method comprising:
calculating the link variance across the communications link and;
transmitting the signal from the transmitter to the receiver across the communications link during a time slice.

29. The method of claim 28, further comprising the step of buffering the signal when it is received and processing the signal only at the beginning of the next time slice.

30. The method of claim 28, further comprising the step of buffering the signal when it is received and processing the signal only at the beginning of the time slice occurring after the entire signal has been buffered and declared valid.

31. The method of claim 30, further comprising the step of calculating the number of time slices required to receive the signal and declaring the signal valid after the calculated number of time slices have elapsed.

32. The method of claim 28, wherein calculating the link variance comprises determining the time difference between a maximum signal transmission time and a minimum signal transmission time to transmit from the transmitter to the receiver across the communications link.

33. The method of claim 28, wherein the time slice is programmable.

34. The method of claim 28, wherein the transmitter and receiver are located within a fault-tolerant computer system.

35. The method of claim 28, wherein the time slice is calculated to be a period of time greater than the link variance and also the least common denominator between a transmitter clock period and a receiver clock period.

36. The system of claim 22, wherein the time slice is calculated to be a period of time greater than the link variance and also the least common denominator between a transmitter clock period and a receiver clock period.

37. The system of claim 36, wherein the link variance comprises a time difference between a maximum signal transmission time and a minimum signal transmission time to transmit from the transmitter to the receiver across the communications link.
